(19) United States
(12) Patent Application Publication
(10) Pub. No.: US 2019/0020376 A1
(43) Pub. Date: Jan. 17, 2019

(54) LARGE CAPACITY DATA HIGH SPEED TRANSFER SYSTEM, LARGE CAPACITY DATA CARD, AND HOST DEVICE ADAPTOR USED THEREFOR

(71) Applicant: ASSET-WITS CORPORATION, Uji-shi (JP)

(72) Inventors: Hideo MIYAZAWA, Nishinomiya-shi (JP); Shutaro NAMBU, Uji-shi (JP); Junzoh SHIMIZU, Kawasaki-shi (JP); Toshio TAKADA, Sendai-shi (JP)

(73) Assignee: ASSET-WITS CORPORATION, Uji-shi (JP)

(21) Appl. No.: 16/124,174

(22) Filed: Sep. 6, 2018

Related U.S. Application Data
(63) Continuation of application No. PCT/JP2017/009090, filed on Mar. 7, 2017.

(30) Foreign Application Priority Data
Mar. 7, 2016 (JP) 2016-043850

(51) Int. Cl. H04B 5/00

(52) U.S. Cl. CPC H04B 5/0037

(57) ABSTRACT

A large-capacity-data high-speed-transfer system transfers large capacity data at high speed with millimeter-wave near field communication (NFC) from a first host device to a second host device. The system includes: a large capacity data card having a millimeter-wave NFC capability, the large capacity data card being fitted with a typical large capacity data memory capable of storing the large capacity data; and a host device adapter to be connected to a host device including the first host device and the second host device, the host device adapter having the millimeter-wave NFC capability, and executing millimeter-wave NFC communications with the large capacity data card to transfer the large capacity data at high speed between the large capacity data card and a host device to be a destination.

### CROSS-REFERENCE TO RELATED APPLICATIONS

This is a continuation of International Application No. PCT/JP2017/009090 filed on Mar. 7, 2017, which claims priority to Japanese Patent Application No. 2016-043850 filed on Mar. 7, 2016. The entire disclosures of these applications are incorporated by reference herein.

### BACKGROUND

The present disclosure relates to a large-capacity-data high-speed-transfer system. In particular, the present disclosure relates to a large capacity data card which (i) utilizes an inter-device transmission technique on a millimeter-wave (30 GHz to 300 GHz) near field communication (NFC) capability without a network, and (ii) can be fitted with an existing memory card. The present disclosure also relates to a large capacity data distribution service, using the card.

Recently, communication traffic of large capacity data is increasing as image information becomes larger in capacity and communication speed becomes faster. Because of the increasing communication traffic, network congestion poses a big problem. Hence, it has become important to develop a technique for transferring large capacity data without a network. In particular, medical image data is increasing in capacity as the image data is presented in high definition and in the form of video, such as computed tomography (CT), magnetic resonance imaging (MRI), ultrasonic images, X-ray radiography, and gastroscopic images. A typical hospital stores a large capacity data communications network dedicated to communications in large capacity. In the hospital, however, a wireless LAN cannot be used so that the network is built with wire lines. Such a network makes it difficult to flexibly deal with extension and reconstruction of the hospital building. Moreover, along with recent sophistication of medical treatments, medical image data is frequently exchanged between hospitals in need of diagnosis by specialized physicians. In this case, because of such problems as a transfer speed problem and a confidentiality problem, the medical image data is currently transferred not through network; instead, the data is stored in optical discs and passed by hand. However, passing the discs poses serious problems: the capacity of the medical image data is increasing at a fast pace, the frequent exchange of discs is troublesome, and the discs are still vulnerable in confidentiality. Hence, for medical image data, there are increasing requests for high-speed inter-device large capacity data transfer systems and services achieving high confidentiality and fast transfer speed.

Moreover, as to transfer of such data as music, movies, and various videos, an increase in capacity of the data is also fast-paced. When such large capacity data is transferred, the network congestion also poses a problem. Hence, as a new means to facilitate transfer and exchange of the large capacity data, strongly desired is a small-sized high-speed inter-device large capacity data transfer system achieving high confidentiality and fast transfer speed.

Transfer Jet (trademark) is publicly known as a near-field-communication technology for inter device data transfer without network. The technique allows a user to simply touch, with a near-field-communication (NFC)-enabled mobile terminal device, an NFC-enabled data supply device, so that the data can be transferred from the data supply device to the mobile terminal device at a transfer speed ranging from 560 Mbps to 375 Mbps. The NFC-enabled device has a center frequency of 4.48 GHz, and transfers and receives data through an antenna with an induced electric-field coupler. The NFC is compliant with a regulation for an extremely low power radio station; that is, a transmission power of −70 dBm. However, this technique cannot handle high-speed transfer of a large capacity data of 1 Gbps or greater which is required for inter-device transfer of large capacity image data, such as medical image data and movies. Moreover, for building an inter-device transfer system, both the mobile terminal device and the host device need to be modified to be provided with a Transfer Jet technique. Such modification is a high obstacle for the system to be widely used.

On the other hand, another publicly known communication technique (NFC) developed is based on a millimeter-wave high-speed inter-device large capacity data transfer technique with a semiconductor integrated circuit. Such a technique allows for inter-device transfer of large amount of data at a high speed ranging from 1 Gb/s to 20 Gb/s when a user simply brings a millimeter antenna of his or her mobile terminal device closer to, and placing the device over, a millimeter antenna of the host device. This NFC technique is achieved because of development of techniques to manufacture smaller semiconductor integrated circuits and the resulting increase in operating limits of the semiconductors in high frequency, so that a sophisticated modulation technique typically used for semiconductor high frequency circuits can be used for high frequency such as millimeter waves. As a result, the NFC technique makes it possible to transfer large capacity data between devices at high speed.

Japanese Unexamined Patent Publication No. 2012-146237 discloses a millimeter-wave communication card including: a millimeter-wave band wave guide, a millimeter-wave band large-capacity-data high-speed transfer semiconductor circuit, and a semiconductor memory. When the millimeter-wave communication card is placed over the wave guide for a millimeter-wave antenna on a card slot within an electronic device, large capacity data can be transferred at high speed between a memory card and the electronic device. Moreover, WO 2016/020951 discloses a millimeter-wave band communication memory card including: a secure digital (SD) card; a millimeter-wave flat panel antenna, provided on the SD card, for transmission and reception; a millimeter-wave band NFC large-capacity-data high-speed transfer semiconductor circuit; and a semiconductor memory. Furthermore, as disclosed in Japanese Unexamined Patent Publication No. 2015-133569, Japanese Unexamined Patent Publication No. 2013-218649, and Japanese Unexamined Patent Publication (Translation of PCT Application) No. 2009-522662, a memory adapter including a memory card socket provided with NFC capability and having enhanced confidentiality is publicly known.

However, both of the techniques disclosed in Japanese Unexamined Patent Publication No. 2012-146237 and WO 2016/020951 have such problems: (1) the millimeter-wave communication (NFC) capability is integrated into a memory package, such that the techniques alone cannot handle data of an existing memory card; (2) because of the problem (1), the techniques have difficulty in coping with a state-of-the-art media for storing large capacity data and in adding high confidentiality and a function for analyzing a special format, and functions provided by the technique are limited; (3) in order to build a high-speed inter-device large capacity data transfer system, a large capacity data card fitted with a millimeter-wave antenna needs to be inserted in a card slot of both a mobile terminal device and a host electronic device; (4) because of the problem (3), both the mobile terminal device and the host device need to be modified, causing an increase in costs and making it difficult for practical application of the techniques; (5) the techniques are vulnerable in confidentiality; (6) a new secure digital (SD) card needs to be standardized for both the card and host devices, making it difficult for practical application of the techniques; and (7) flexibility in designing the card is little.

Moreover, both Japanese Unexamined Patent Publication No. 2015-133569 and Japanese Unexamined Patent Publication (Translation of PCT Application) No. 2009-522662 facilitate a modification and simplify configurations of mobile terminal devices for inter-device transfer of data; however, neither publication is silent as to a modification and a configuration of a host device required for a high-speed inter-device large capacity data transfer system. In addition, the publications do not disclose either a power supply required for a large-capacity-data high-speed-transfer system or a specific large-capacity-data high-speed-transfer system. Hence, neither of the above publications is directed to a high-speed inter-device large-capacity-data transfer system.

The present disclosure is conceived in view of the above problems, and intends to provide a large-capacity-data high-speed-transfer system capable of transferring large capacity data between devices at high speed with high confidentiality. The present disclosure also intends to provide a large capacity data card and a host device adopter to be used for the system.

### SUMMARY

A large-capacity-data high-speed-transfer system according to a first aspect of the present disclosure transfers large capacity data at high speed with millimeter-wave near field communication (NFC) from a first host device to a second host device. The system includes: a large capacity data card having a millimeter-wave NFC capability, the large capacity data card being fitted with a typical large capacity data memory capable of storing the large capacity data; and a host device adapter to be connected to a host device including the first host device and the second host device, the host device adapter having the millimeter-wave NFC capability, and executing millimeter-wave NFC communications with the large capacity data card to transfer the large capacity data at high speed between the large capacity data card and a host device to be a destination.

The present disclosure can implement a new and small-sized large capacity data card, utilizing millimeter-wave NFC, having high confidentiality and capable of transferring data at a high speed ranging from 1 Gb/s to 20 Gb/s. The present disclosure can also implement a large-capacity-data high-speed-transfer system using the large capacity data card.

### BRIEF DESCRIPTION OF THE DRAWINGS

FIG. 1 is a drawing illustrating a large-capacity-data high-speed-transfer system according to an embodiment of the present disclosure.

FIG. 2 is a drawing illustrating a large-capacity-data high-speed-transfer system according to another embodiment of the present disclosure.

FIG. 3 is a drawing illustrating constituent elements of a large capacity data card and a host device adapter.

FIG. 4 is a drawing illustrating a wireless power supply operating at low frequency, the wireless power supply being provided to the host device adapter as a power supply circuit for the large capacity data card.

FIG. 5 is a drawing illustrating a large-capacity-data high-speed-transfer system according to a modification.

FIG. 6 is a drawing illustrating an example of the embodiment in FIG. 1.

FIG. 7 is a drawing illustrating an example of the embodiment in FIG. 2.

FIG. 8 is a drawing illustrating another example of the embodiment in FIG. 2.

FIG. 9 is a drawing illustrating still another example of the embodiment in FIG. 2.

FIG. 10 is a drawing illustrating a large capacity data card according to another embodiment.

FIG. 11 is a drawing illustrating a large capacity data card according to still another embodiment.

### DETAILED DESCRIPTION

Described below are embodiments of the present disclosure, with reference to the drawings. Here a common SD, a common solid state drive (SSD), and a large capacity data memory in compliance with Institute of Electrical and Electronics Engineers (IEEE) mean information storage devices assumed to be typically available and removable. These information storage devices either (i) use an electric-coupled device, a magnetic-coupled device, or an organic-coupled device, or (ii) utilize a quantum effect. An interface for the common SD, the common SSD, and the large capacity data in compliance with the IEEE means, for example, a connector capable of physical connection for an electric signal.

A millimeter-wave radio frequency (RF) means a large capacity NFC capability.
A cryptographic capability means two capabilities; namely, encryption and decryption.
A controller is capable of reading the data stored in the common SD, the common SSD, or the large capacity data memory in compliance the IEEE, and of writing data on the SD, the SSD, or the memory. The controller acts as a host.
Moreover, a storage analysis capability is for analyzing either (i) the data stored in the common SD, the common SSD, or the large capacity data storage device in compliance with the IEEE, or (ii) a data structure assumed for a specific purpose, and for checking suitability of the data or the data structure.

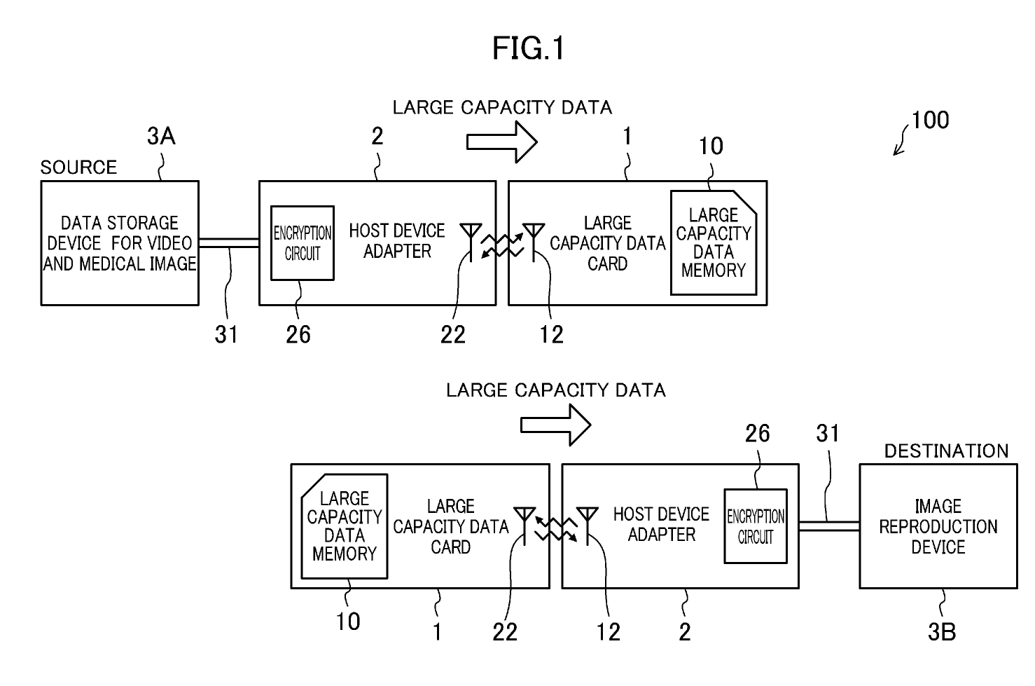

FIG. 1 is a schematic illustration of a large-capacity-data high-speed-transfer system according to an embodiment of the present disclosure. In this embodiment, a host device adapter 2 including a millimeter-wave high-speed-transfer circuit is connected to an image storage device (a first host device 3A) for such images as medical image data and a video. First, from the adapter 2 to a large capacity data card 1 including a millimeter-wave high-speed-transfer circuit, the medical image data is transferred with millimeter-wave NFC. The large capacity data card 1 is fitted with a large capacity data memory 10. The medical image data is temporarily held in the large capacity data memory 10. Next, the medical image data is transferred with the millimeter-wave NFC from the large capacity data card 1 to a large capacity data reproduction device (a second host device 3B) through the host device adapter 2 including the millimeter-wave high-speed-transfer circuit connected as described above. Here, the large capacity data reproduction device is, for example, a workstation which is a destination of the medical image data to be transferred.

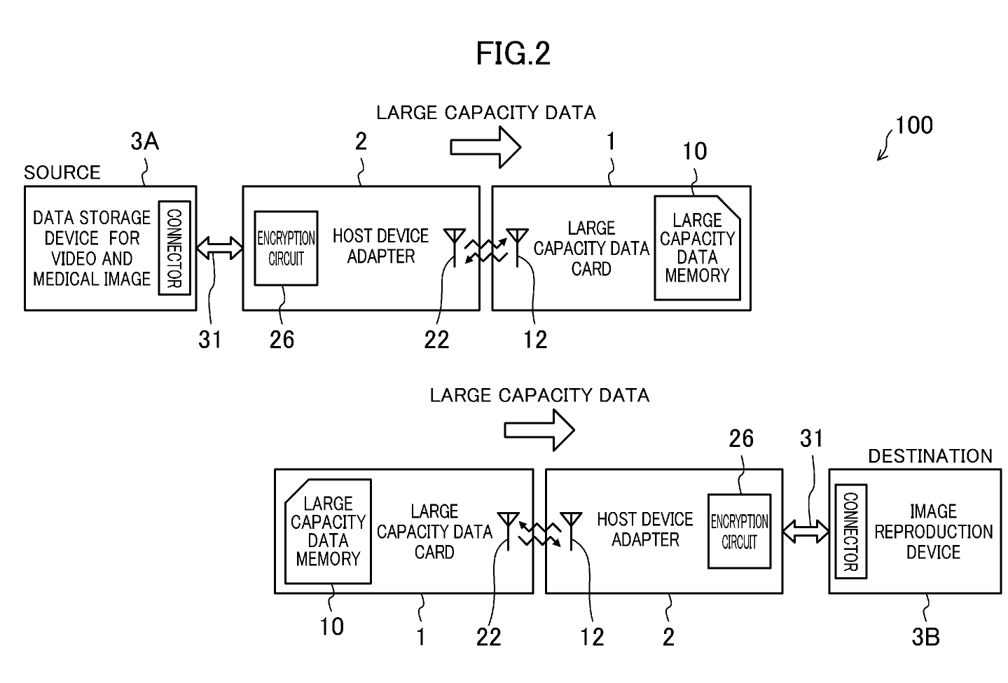

The host device adapter 2 may be either (i) a module to be connected to the host devices 3A and 3B through a data cable 31 as illustrated in FIG. 1 or (ii) a card to be connected to the host devices 3A and 3B through a connector 32, such as a universal serial bus (USB), fitted to the host devices 3A and 3B as illustrated in FIG. 2. Moreover, the adapter 2 is configured to conduct the millimeter-wave inter-device communication through an encryption circuit 26. Such a feature can ensure confidentiality of data transmitted via the communication circuit. Moreover, in a similar manner, such a function for analyzing a special format can be easily added, for example.

As can be seen, in this embodiment, the new large capacity data card 1 and the host device adapter 2 can easily provide a capability for inter-device transfer of large capacity data to the image storage device 3A for images such as existing medical image data and a video and the large capacity data reproduction device 3B as the destination of the large capacity data to be transferred. Moreover, this embodiment makes it possible to (1) handle data stored in an existing memory card, (2) build a high-speed inter-device large-capacity-data transfer system at low cost without a modification of a mobile terminal device and a host device, (3) achieve high degree of confidentiality, (4) facilitate practical application of the large-capacity-data high-speed-transfer system, and (5) design the card in larger flexibility. Such features can solve typical problems.

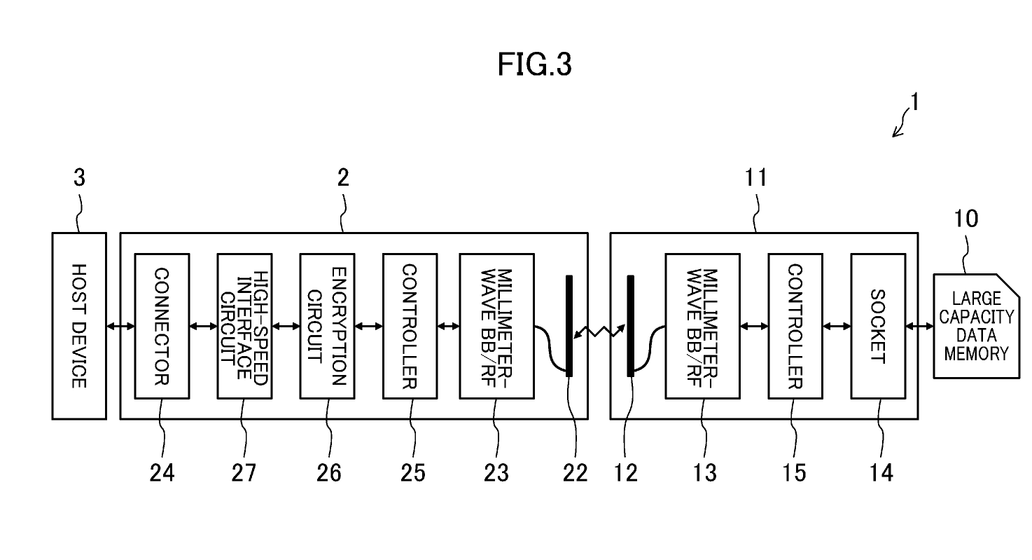

FIG. 3 illustrates an example of the large capacity data card 1 and the host device adapter 2 in FIGS. 1 and 2. In FIG. 3, the large capacity data card 1 includes: a planar substrate 11 shaped into any give shape and provided with a millimeter-wave antenna 12, a millimeter-wave NFC integrated circuit 13, a memory socket 14, and a memory controlling controller 15. Note that the large capacity data memory 10 may be any given device. Examples of the large capacity data memory 10 includes a common SD card, SSD, compact flash (CF) card, CFast card, USB memory, MiniSD card, and MicroSD card. Moreover, the large capacity data memory 10 may be fitted via the standardized memory socket 14 such as an SD card and a SSD, or may be mounted directly on the planer substrate 11.

Furthermore, the large capacity data card 1 itself is free from any standard, and can be designed flexibly in shape. Hence, the large capacity data card 1 may be designed and shaped in various manners to suit tastes of users.

As illustrated in FIGS. 1 and 2, in the inter-device transfer through the large capacity data card 1 having the millimeter-wave NFC capability according to this embodiment, the adapter 2 having a similar millimeter-wave NFC capability is required for the image storage device 3A for CT and MRI and for the image reproduction device 3B such as a workstation as the destination of the data to be transferred. In this embodiment, as illustrated in FIG. 3, the host device adapter 2 may include a standard connector 24 to be fitted to the host device 3 and configured as a card or a stick shaped to have, for example, a USB connector. Such a feature allows this host device adapter 2 to easily provide the host device 3 with a capability of the large capacity data storage device having the NFC capability without modifying the host device 3 for newly providing the NFC capability.

In FIG. 3, the host device 3 is either (i) a large capacity data storage device for medical image data of, for example, CT and MRI, movies, and game software, or (ii) an image reproduction device, such as a medical workstation, a PC, and a TV, acting as a destination of the large capacity image data. Through a not-shown connector of the host device 3, the host device adapter 2 is fitted to the host device 3. In addition to a millimeter-wave antenna 22 and a millimeter-wave NFC integrated circuit 23, the host device adapter 2 includes: a high-speed interface circuit 27; the encryption circuit 26; a controller 25; and the standard connector 24. The high-speed interface circuit 27 converts the large capacity data, held in a not-shown memory within the host device 3, into serial data for high speed transfer. The encryption circuit 26 ensures confidentiality of the data transmitted through the communication path. The controller 25 controls the processing executed by the high speed interface circuit 27 and the encryption circuit 26. The standard connector 24 is connected to a not-shown connector of the host device 3. Note that the details of the data stored in the large capacity data memory 10 have been previously encrypted by the host device 3 storing the data. The encryption is deciphered by the host device 3; that is, the destination of the data. Note that the encryption circuit 26 may precede the high-speed interface circuit 27 receiving the data from the connector 24. Moreover, an identification (ID) code has been previously registered, for each card, in the controller 15 of the large capacity data card 1. Hence, the encryption circuit 26 and the controller 25 of the host device adapter 2 can identify the code.

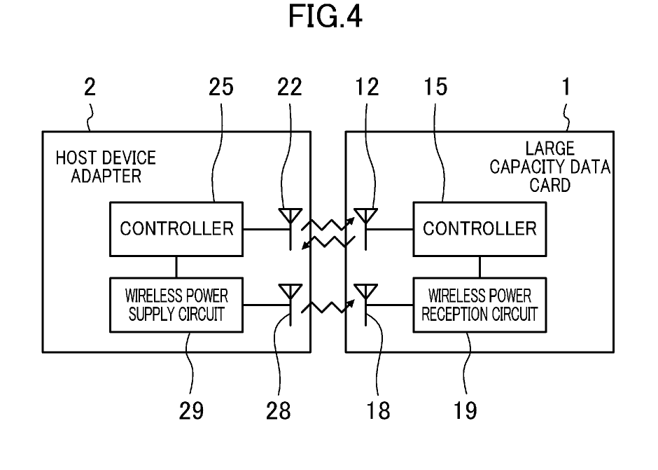

Moreover, the power supply to the large capacity data card 1 can be wirelessly supplied via the millimeter-wave antennas 22 and 12. For example, as an example in FIG. 4 illustrates, the host device adapter 2 is provided with a low-frequency antenna 28 and a wireless power supply circuit 29, and the large capacity data card 1 is provided with a low-frequency antenna 18 and a wireless power reception circuit 19. Such a feature can easily implement a wireless power supply system.

Moreover, as a modification, the large capacity data card 1 having the millimeter-wave NFC capability may be provided with a standard connector to be fitted to the host device 3. From the NFC circuit provided in the image data storage device (the first host device 3A) acting as a supplier of the data, the large capacity data may be transferred with the NFC to the large capacity data card 1. The large capacity data card 1 may be directly connected to a terminal of the standard connector for the host device (the second host device 3B) to be a destination of the transferred data. As a result, the large capacity data can be transferred at high speed between the devices. In contrast, the NFC circuit may be provided in the host device. The large capacity data may be transferred to the large capacity data card 1 from the terminal of the standard connector for the image data storage device (the first host device 3A). The large capacity data may be transferred to the host device (the second host device 3B) to be a destination of the transferred data. As a result, the large capacity data can be transferred at high speed between the devices.

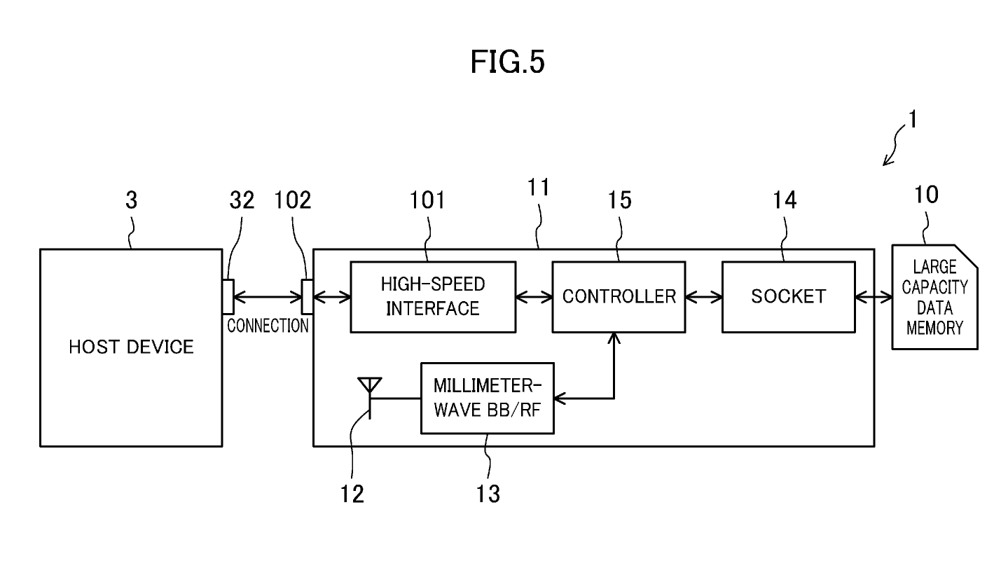

FIG. 5 illustrates such examples. FIG. 5 shows a functional configuration in which the large capacity data from the large capacity data memory 10 is transferred to the host device 3 through the controller 15 of the large capacity data card 1, a data format converter (a high-speed interface) 101, a standard connector 102, and a standard connector 32 of the host device 3. Note that the standard connector 32 to be connected to the host device 3 may have multiple connectors, instead of a single connector, in order to increase versatility of the standard connector 32.

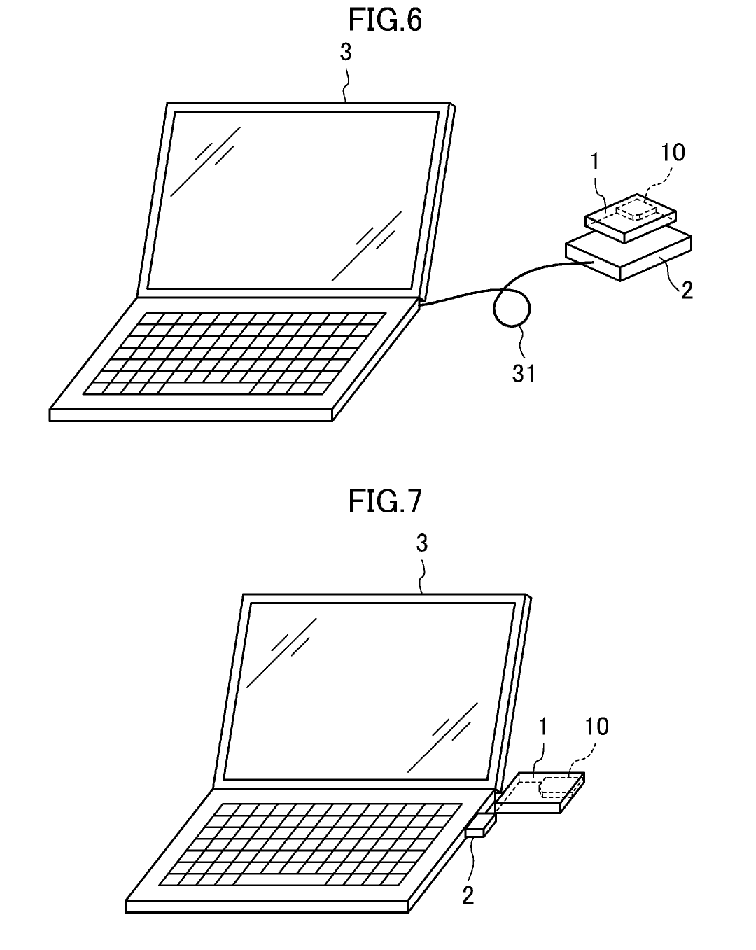

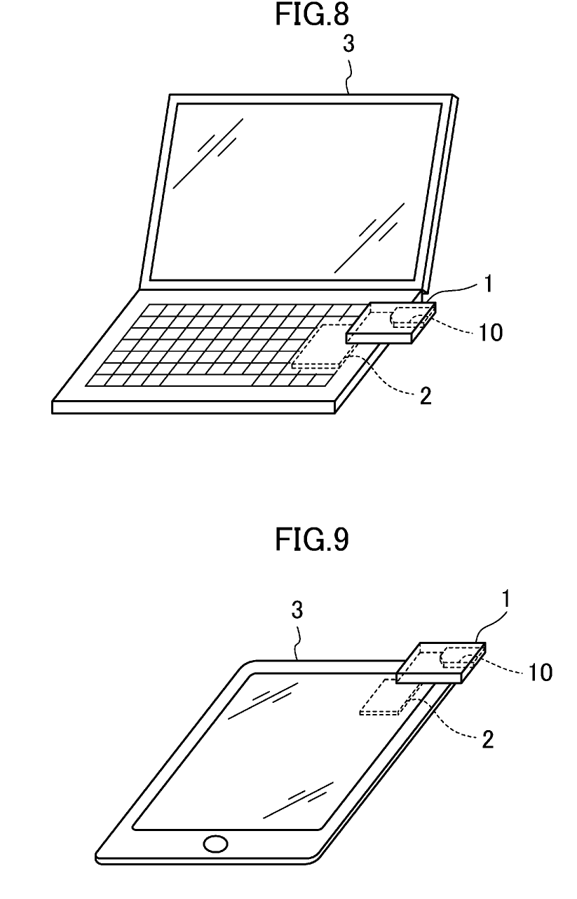

FIG. 6 illustrates an example of the embodiment in FIG. 1. For example, a PC (the host device 3) and the host device adapter 2 are connected together with the data cable 31. The large capacity data card 1 is brought closer to the adapter 2, so that the large capacity data can be transferred between the large capacity data memory 10 in the large capacity data card 1 and the host device 3. FIG. 7 illustrates an example of the embodiment in FIG. 2. For example, the host device adapter 2 is connected to the standard connector provided to the PC (the host device 3). The large capacity data card 1 is brought closer to the adapter 2, so that the large capacity data can be transferred between the large capacity data memory 10 in the large capacity data card 1 and the host device 3. Note that, as illustrated in FIG. 8, the host device adapter 2 may be built into the host device 3. In this case, the large capacity data card 1 is brought closer to the host device 3 such that the large capacity data can be transferred between the large capacity data memory 10 in the large capacity data card 1 and the host device 3. Moreover, as illustrated in FIG. 9, the host device adapter 2 is built into a tablet terminal (the host device 3). Then, the large capacity data card 1 is brought closer to the tablet terminal such that the large capacity data can be transferred between the large capacity data memory 10 in the large capacity data card 1 and the tablet terminal.

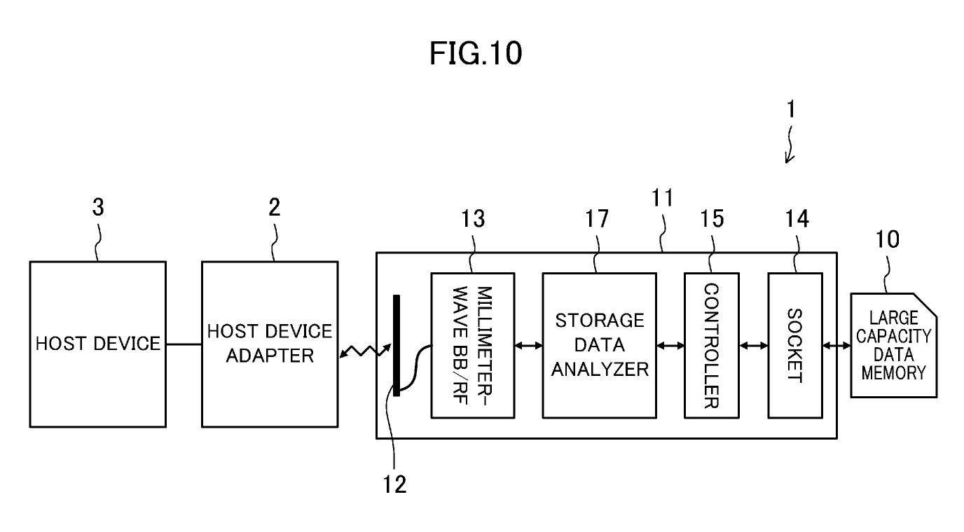

FIG. 10 illustrates the large capacity data card 1 according to another embodiment. The large capacity data card 1 includes: the millimeter-wave antenna 12; the millimeter-wave NFC integrated circuit 13; and the controller 15. The large capacity data card 1 additionally has a high encryption capability and includes an SS-MIX2 storage data analyzer 17. The SS-MIX2 is a medical data format. This storage data analyzer 17 analyzes a data structure of standard large capacity data before wireless transmission or during wireless reception of the data, determines suitability or a damage status of the data before the transmission, and informs a target system of the determination result.

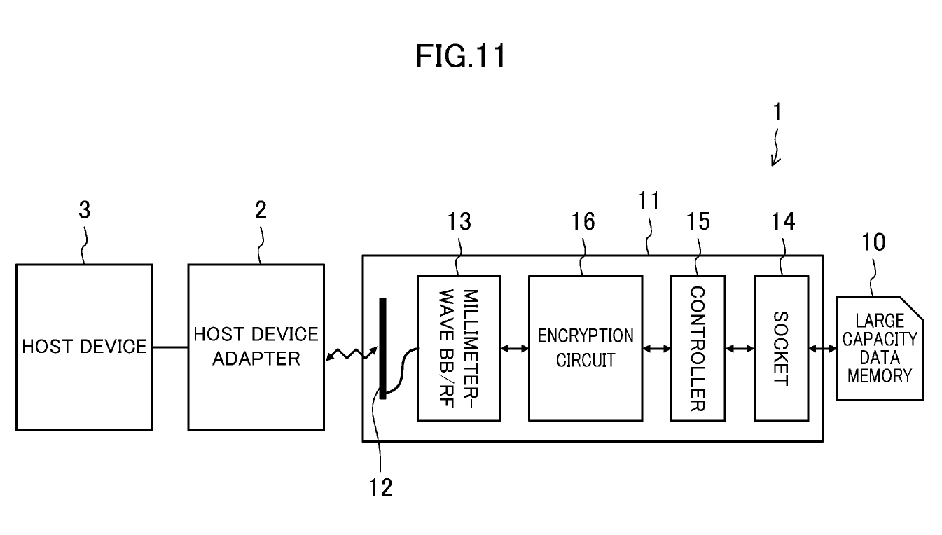

FIG. 11 illustrates the large capacity data card 1 according to still another embodiment. Instead of the storage data analyzer 17 in FIG. 10, the large capacity data card 1 is provided with an encryption (encryption and decryption) circuit 16 to enhance confidentiality of the data stored in the large capacity data memory 10. This encryption (encryption and decryption) circuit 16 encrypts or decrypts the data transmitted and received by the controller 15, so that the host device 3 can transmit and receive the large capacity data through the millimeter-wave NFC integrated circuit 13 and the millimeter-wave antenna 12. In this case, the data stored in the large capacity data memory 10 has already been encrypted by the host device 3. The data can be additionally encrypted by the encryption circuit 16, further enhancing confidentiality of the data stored in the large capacity data memory 10.

The large-capacity-data high-speed-transfer system 100 according to this embodiment is applied as follows: Large capacity data including contents data such as many movies and games, and software is previously distributed to and stored in many information terminal devices (the first host device) installed in such places as convenience stores. From one of the information terminal devices, a customer transfers desired contents data of his or her to his or her large capacity data card 1. Furthermore, the customer transfers the large capacity data to his or her image reproduction device (a consumer device) to use the data. Such an application makes it possible to implement a large capacity image data distribution service. This service allows the large capacity data to be transferred between devices without a network, contributing to alleviating network congestion in distribution of the large capacity data.

In order to charge a fee for the large capacity data distribution service, protection against an unauthorized use of the system is essential. There are various known encryption techniques for providing such protection. The encryption circuit 26 and the controller 25 of the host device adapter 2 and the controller 15 of the large capacity data card 1 easily provide capabilities of the encryption techniques to the large capacity data card 1. An example of such capabilities is as follows: the encryption circuit 26 reads a file creation time data set from the data stored in the large capacity data memory 10, and as necessary, the controller 15 automatically deletes data in the large capacity data memory 10 and makes the data stored in the large capacity data memory 10 unusable unless a certain condition is satisfied.

As can be seen, according to the present disclosure, the large capacity data card 1 has an innovative millimeter-wave NFC capability solving the problems of a typical millimeter-wave high-speed-transmission large capacity data card, and the adapter 2 is to be easily fitted to the host device 3 and has a millimeter-wave NFC capability. The large capacity data card 1 and the adapter 2 can implement a high-speed inter-device data transfer system utilizing a millimeter-wave high-speed large-capacity-data transfer technique which is used to be difficult to utilize. As a result, large capacity data can be transferred on millimeter waves at high speed between devices through the large capacity data card 1 having the millimeter-wave NFC capability, contributing to alleviating network congestion.

The large capacity data card 1 according to the embodiments employs NFC compliant with a regulation for an extremely low power radio station. Hence, the large capacity data card 1 can be produced at low cost and widely used with ease.

In particular, the capacity of the medical image data for, for example, CT, MRI, ultrasonic wave images, X-ray radiography, and gastroscopic images increases at a fast pace as the image data is presented in high definition and in the form of video thanks to advancement of information technology. In order to develop techniques for early diagnosis essential for extending a healthy life-span recently attracting rising attention, it is a matter of urgency to develop a high-speed inter-device large-capacity-data transfer technique not depending on people or network and having high confidentiality. The present disclosure can implement a high-speed inter-device large-capacity-data transfer system and service achieving high confidentiality and fast transfer speed. Hence, a great demand for the system and service is expected.

Moreover, as to transfer of such data as music, movies, and various videos, the capacity of the data increases at a fast pace because of the development of IT technology. When such large capacity data is transferred, the network congestion poses a problem. Hence, a high demand is expected to the high-speed inter-device large-capacity-data transfer system and service of the present disclosure as a new means to facilitate transfer and exchange of the large capacity data, because the system is small in size, high in confidentiality, and fast in transfer speed. For example, a current rental business of movies and game software contents has to store a significantly large number of DVDs and CDs. The business is operated as follows: The business is run at a large store. Out of large amount of displayed software contents, a customer selects software contents of his or her desire. The customer rents the software contents according to a predetermined procedure, and watches the software contents for a certain time period. After that, the customer returns the software contents. However, the amount of content is excessively large. Hence, customers have found it difficult to search for and select contents of their desire. The present disclosure can implement a new business model as follows: A simple information terminal device (a KIOSK terminal) is installed in a small shop such as a convenience store. A customer selects software contents of his or her desire with a simple search. The customer transfers image data of the software contents to the large capacity data card 1 having the millimeter-wave NFC capability according to the embodiments. After that, the customer transfers the data from the large capacity data card 1 to an image reproduction device in his or her home, and watches the software contents. Moreover, the image data in the large capacity data card 1 can be easily provided with such features: the data disappears in a certain period of time; and the disappearance of the data can be postponed if the customer pays an extra fee for the postponement. As a result, the rental business of movies and game software contents can be run at fixed costs significantly lower than current fixed costs. Hence, a high demand can be expected.

A large-capacity-data high-speed-transfer system according to the present disclosure can transfer large capacity data between devices at high speed with high confidentiality. Moreover, the system allows an existing large capacity memory card to be used as it is, and the card to be designed more flexibly. In particular, the present disclosure is useful for inter-device transfer of medical image data in a hospital and of contents data such as movie software contents and game software contents.

What is claimed is:

1. A large-capacity-data high-speed-transfer system which transfers large capacity data at high speed with millimeter-wave near field communication (NFC) from a first host device to a second host device, the system comprising:
a large capacity data card having a millimeter-wave NFC capability, the large capacity data card being fitted with a typical large capacity data memory capable of storing the large capacity data; and
a host device adapter to be connected to a host device including the first host device and the second host device, the host device adapter having the millimeter-wave NFC capability, and executing millimeter-wave NFC communications with the large capacity data card to transfer the large capacity data at high speed between the large capacity data card and a host device, including the first host device and the second host device, to be a destination.

2. The large-capacity-data high-speed-transfer system of claim 1, wherein
the host device adapter is either (i) a module to be connected to the host device through a data cable, or (ii) a card to be connected to a standard connector provided to the host device.

3. The large-capacity-data high-speed-transfer system of claim 1, wherein
the host device adapter includes a wireless power supply circuit, and
the large capacity data card includes a wireless power reception circuit, and operates on power wirelessly supplied from the host device adapter.

4. The large-capacity-data high-speed-transfer system of claim 1, wherein
the first host device is a medical diagnosis device for such diagnoses as computed tomography (CT), magnetic resonance imaging (MRI), and ultrasonic diagnosis,
the second host device is a medical terminal device including a medical work station, and
the large capacity data includes a medical image and video data.

5. The large-capacity-data high-speed-transfer system of claim 1, wherein
the first host device is an information terminal device storing contents data including movie software and game software,
the second host device is a consumer device including a television receiver, a personal computer, and a tablet terminal, and
the large capacity data includes the contents data.

6. The large-capacity-data high-speed-transfer system of claim 5, wherein
as a storage period of the contents data stored in the large capacity data memory exceeds a predetermined time period, the large capacity data card is capable of destroying the contents data or making the contents data unusable unless a certain condition is satisfied.

7. A large capacity data card to be used for the large-capacity-data high-speed-transfer system of claim 1, the large capacity data card comprising
a millimeter-wave antenna, a millimeter-wave NFC integrated circuit, a socket, and a controller all of which are mounted on a planer substrate shaped into any given shape, the socket being fitted with the large capacity data memory, and the controller managing an identification number of the large capacity data card and controlling data transfer between the large capacity data memory and the host device.

8. A host device adapter to be used for the large-capacity-data high-speed-transfer system of claim 1, the host adapter comprising
a millimeter-wave antenna, a millimeter-wave NFC integrated circuit, a standard connector to be connected to the host device, a high-speed interface circuit, an encryption circuit, and a controller, the high-speed interface circuit converting the large capacity data received from the large capacity data card into a high-speed serial signal, the encryption circuit encrypting and decrypting the large capacity data, and the controller controlling data transfer between the host device and the large capacity data card.
